(19) United States
(12) Patent Application Publication
(10) Pub. No.: US 2015/0303753 A1
(43) Pub. Date: Oct. 22, 2015

(54) OUTER ROTOR BRUSHLESS MOTOR

(71) Applicant: Johnson Electric S.A., Murten (CH)

(72) Inventors: Ning HUANG, Shenzhen (CN); James Ching Sik LAU, Hong Kong (CN); Bhoopal PONNUVELU, Hong Kong (CN)

(21) Appl. No.: 14/693,450

(22) Filed: Apr. 22, 2015

(30) Foreign Application Priority Data
Apr. 22, 2014 (CN) 201410164464.6

(51) Int. Cl. H02K 1/30; B29C 45/14; H02K 15/03; H02K 1/27; H02K 9/06

(52) U.S. Cl. CPC H02K 1/30; H02K 1/2786; H02K 9/06; H02K 15/03; B29C 45/14008; B29C 45/14491; B29K 2101/00

(57) ABSTRACT

An outer rotor for a brushless motor has an end plate; a shaft fixed to a rotary center of the end plate; and an annular rotor core having one end connected to the end plate. A plurality of connecting bars connect the rotor core to the end plate. Permanent magnets are fixed to an inner surface of the rotor core. The end plate has an outer diameter equal to or less than the outer diameter of the rotor core. The end plate has a base plate, an annular sidewall, and a plurality of fan blades interconnecting the base plate and the sidewall. There are openings between the fan blades. The end plate is insert molded to the shaft and the connecting bars.

### CROSS REFERENCE TO RELATED APPLICATIONS

This non-provisional patent application claims priority under 35 U.S.C. §119(a) from Patent Application No. 201410164464.6 filed in The People's Republic of China on Apr. 22, 2014, the entire contents of which are hereby incorporated by reference.

### FIELD OF THE INVENTION

This invention relates to brushless motors and in particular, to an outer rotor brushless motor.

### BACKGROUND OF THE INVENTION

There is a type of brushless motor that has a stator and an outer rotor. The outer rotor includes an annular rotor core, an end plate attached to an outer surface of the rotor core, and a shaft fixed to a center of the end plate. However, this type of brushless motor requires a large number of steps to assemble. In addition, the power density of the motor is relatively low due to the way the rotor is constructed.

### SUMMARY OF THE INVENTION

Hence there is a desire for a brushless motor having an improved outer rotor.

Accordingly, in one aspect thereof, the present invention provides an outer rotor for a brushless motor, comprising: an end plate; a shaft fixed to a rotary center of the end plate; an annular rotor core having one end connected to the end plate; and a plurality of connecting bars extending in an axial direction of the rotor core, each connecting bar having a first end fixed to the rotor core and a second end fixed to the end plate.

Preferably, the second ends of the connecting bars protrude out of the rotor core, and the end plate is fixed to the second ends of the connecting bars and the shaft by insert-molding.

Preferably, the second ends of the connecting bars comprise detent structures for reinforcing the connection between the connecting bars and the end plate.

Preferably, the outer rotor further comprises a plurality of permanent magnets attached to an inner surface of the rotor core and distributed in a circumferential direction of the rotor.

Preferably, the end plate comprises a base plate, a sidewall, and a plurality of fan blades interconnecting the base plate and the sidewall and integrally formed with the base plate and the sidewall, the fan blades surround the shaft, openings are formed between adjacent fan blades for passage of airflow generated by rotation of the fan blades.

Preferably, the rotor core is formed by stacking a plurality of core laminations in an axial direction of the rotor, each core lamination has pre-formed connecting holes, the connecting bars extend through the connecting holes of the rotor core, first ends of the connecting bars comprise bar heads, and second ends of the connecting bars protrude out of the rotor core.

Preferably, the bar heads engage with a reinforcing ring disposed against an axial end of the rotor core remote from the end plate.

Preferably, an outer diameter of the end plate is less than or equal to an outer diameter of the rotor core.

According to a second aspect, the present invention provides a brushless motor comprising a stator and the outer rotor described above. The stator comprising a base and a stator core fixed to the base. The base comprises a bearing for supporting the shaft. The stator core is at least partially surrounded by the rotor core.

According to a third aspect, the present invention provides a method of making an outer rotor for a brushless motor, comprising: providing a rotor core with a plurality of connecting bars, first ends of the connecting bars being connected with the rotor core, and second ends of the connecting bars protruding out of the rotor core in an axial direction of the rotor core; placing a shaft and the rotor core with the connecting bars into a mold, with the shaft located at a rotary center of the rotor core; and injection molding an end plate, and fixing the end plate, the second ends of the connecting bars and the shaft together by insert-molding.

Preferably, after injection molding of the end plate is completed, a number of permanent magnets are mounted to an inner surface of the rotor core.

Preferably, during injection molding of the end plate, the method further comprises the step of: forming the end plate with a base plate, an annular sidewall and a plurality of fan blades interconnecting the base plate and the sidewall, and openings between the fan blades for the passage of airflow.

In view of the foregoing, the fixed connection between the end plate and the rotor core is realized by using the connecting bars. Therefore, the end plate needs not wrap the outer surface of the rotor core, thus reducing the outer diameter of the motor end plate. In addition, by injection molding the end plate, the number of assembly steps to produce the motor is reduced, which enhances the assembly efficiency.

### BRIEF DESCRIPTION OF THE DRAWINGS

Preferred embodiments of the invention will now be described, by way of example only, with reference to figures of the accompanying drawings. In the figures, identical structures, elements or parts that appear in more than one figure are generally labeled with a same reference numeral in all the figures in which they appear. Dimensions of components and features shown in the figures are generally chosen for convenience and clarity of presentation and are not necessarily shown to scale. The figures are listed below.

FIG. 1 illustrates a brushless motor according to the preferred embodiment of the present invention;

FIG. 2 illustrates an stator of the brushless motor of FIG. 1;

FIG. 3 illustrates a base of the stator of FIG. 2;

FIG. 4 illustrates an outer rotor of the brushless motor of FIG. 1;

FIG. 5 is a sectional view of the outer rotor of FIG. 4;

FIG. 6 illustrates an end plate of the outer rotor of FIG. 4; and

FIG. 7 is a flowchart showing steps involved in making the outer rotor of FIG. 4.

### DETAILED DESCRIPTION OF THE PREFERRED EMBODIMENTS

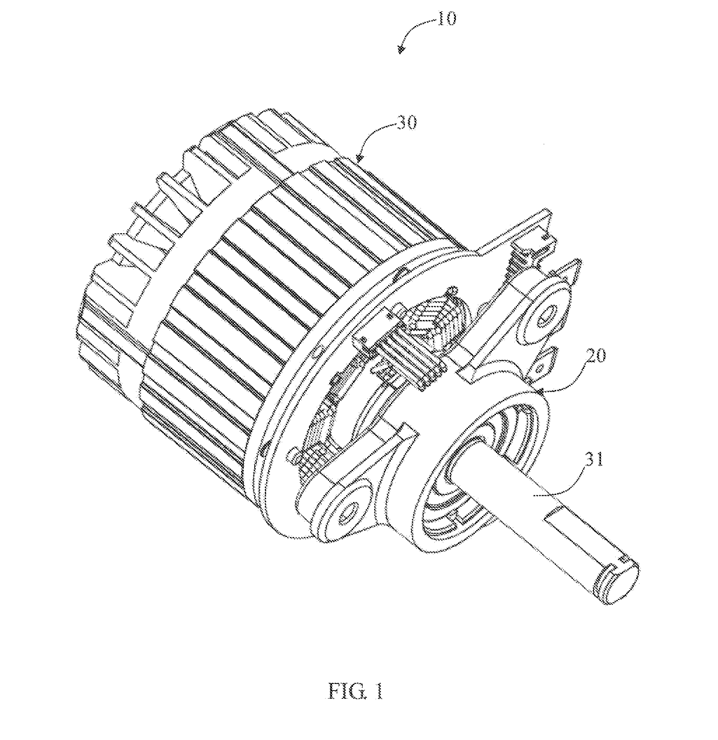

An outer rotor brushless motor 10, as shown in FIG. 1, has a stator 20 and an outer rotor 30. The outer rotor 30 is rotatably mounted around the stator 20. The outer rotor has a shaft 31 extending through the stator 20 along a center axis of the stator 20.

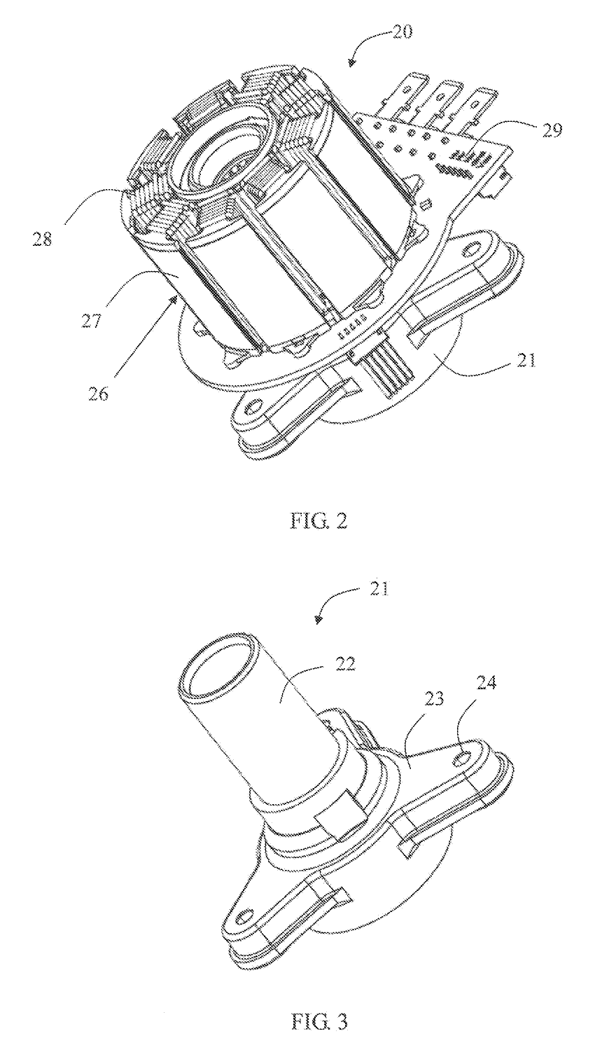

Referring to FIG. 2 and FIG. 3, the stator 20 comprises a base 21, a stator core 26 fixed to the base 21, and a stator winding 28 wound around teeth 27 of the stator core. A circuit board 29 is mounted to the base 21 or a winding support bracket of the stator core 26. The base 21 includes a hollow sleeve 22 and a mounting block 23 disposed at one end of the sleeve 22. The mounting block 23 includes three mounting arms extending radially outwardly. A mounting hole 24 is formed at an outer end of each mounting arm, such that the stator can be fixedly mounted to desired positions by using fasteners such as screws or bolts that pass through the mounting holes 44. A bearing may be mounted in the sleeve 22, for rotatably supporting the shaft 31. Alternatively, the sleeve may form a bearing in the form of a bushing to directly support the shaft.

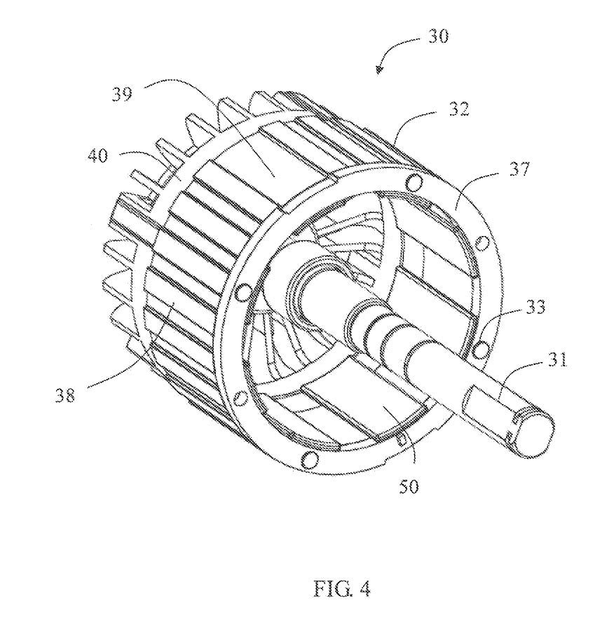

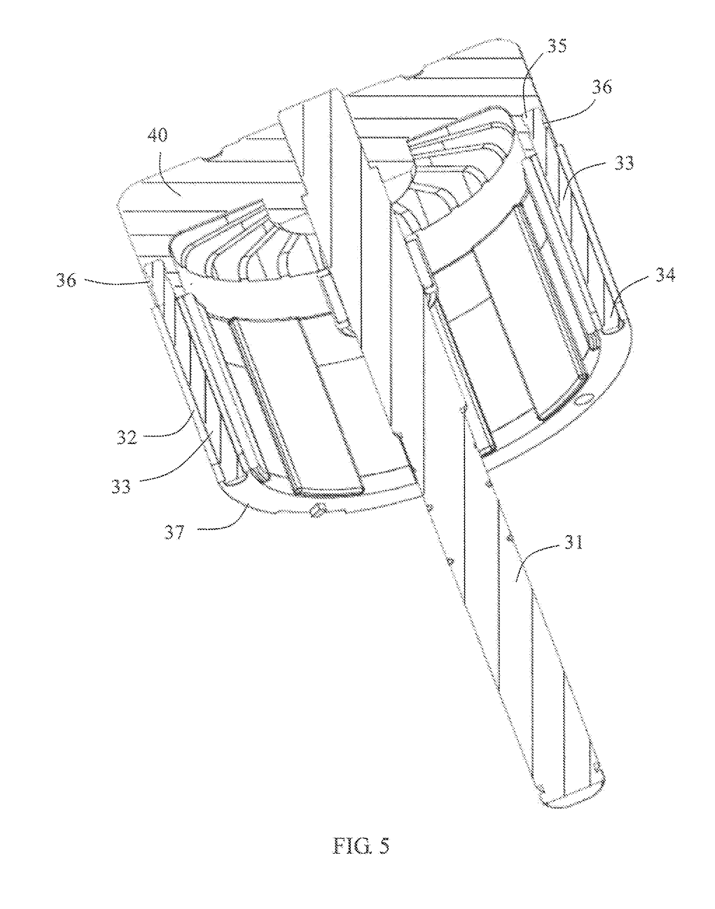

Referring to FIGS. 4 & 5, the rotor 30 comprises an annular rotor core 63, an end plate 40 fixed to one end of the rotor core 32, the shaft 31 fixed to a rotary center of the end plate 40, and permanent magnets 50 mounted to an inner surface of the rotor core 32. The permanent magnets 50 and the teeth 27 of the stator core 26 confront each other across a small air gap. The rotor core 32 is formed by a plurality of core laminations stacked in the axial direction of the rotor. Connecting bars 33 extending in the axial direction are inserted into connecting holes formed in the core laminations to fix the core laminations together. A first end 34 of each connecting bar 33 (remote from the end plate 40) has a bar head which prevents the core laminations from becoming disengaged from the connecting bar. The other or second end 35 of each connecting bar 33 protrudes from the rotor core 32 and is fixed to the end plate 40. A wall thickness of the rotor core 32 in the radial direction is greater than an outer diameter of each connecting bar 32. In this embodiment, a reinforcement ring 37 is disposed at the end of the rotor core 32 remote from the end plate 40 and is engaged with the bar head. It should be understood that the reinforcement ring 37 may be omitted in another embodiment.

Preferably, the rotor core 32 comprises a plurality of ribs 38 on an outer surface of the rotor core 32, for increasing the heat dissipation area of the rotor core 32. In addition, a plurality of positioning planes 39 is disposed on the outer surface of the rotor core 32. The positioning planes are used to engage with rails of a mold for positioning purposes when the end plate 40 is formed by insert-molding.

Referring to FIG. 5, the second ends 35 of the connecting bars 33 protrude out of the rotor core 32 and are inserted into the end plate 40. In this embodiment, the end plate 40 is fixed to the second ends of the connecting bars 33 and the end of the rotor core 32 by insert-molding of the end plate. An outer diameter of the end plate 40 is less than or equal to an outer diameter of the rotor core 32 (here, the outer diameter of the rotor core refers to the largest outer diameter of the rotor core). Preferably, an outer circumferential surface of the end plate 40 is substantially flush with or slightly recessed with respect to the outer surface of the rotor core 32 (i.e. a surface from which the ribs extend, or a circumferential surface on which the positioning planes 39 are located).

Preferably, the second ends 35 of the connector bars 33 have a detent structure 36 such as a protrusion and/or an indentation, for reinforcing the connection between the connecting bar 33 and the end plate 40. In this embodiment, a recess or groove 36 is formed in the second end of the connecting bar 33, which forms a locking groove for reinforcing the connecting between the connecting bar 33 and the end plate 40. In an alternative embodiment, a collar is mounted in the recess for reinforcing the connection between the connecting bar 33 and the end plate 40.

In a traditional outer rotor motor, the end plate of the outer rotor is mounted to the rotor core, with the end plate sleeving around the outer surface of the rotor core. That is, the outer diameter of the end plate is significantly greater than the outer diameter of the outer rotor core. In this embodiment, the outer diameter of the end plate 40 is less than or equal to the outer diameter of the rotor core 32. Therefore, with the same outer diameter of the motor, the rotor core can have a larger outer diameter to increases the power of the motor.

It is to be understood that the rotor core 32 may be of a non-laminated type. For example, the rotor core 32 may be a cylindrical barrel made of magnetically conductive material, and connecting holes are formed at one end of the cylindrical barrel. First ends of the connecting bars 33 are mounted in the connecting holes in an interference-fit manner, and second ends of the connecting bars 33 extend out of the connecting holes in the axial direction of the rotor and are fixed to the end plate. It should be understood that the connecting bars 33 may also be formed integrally on one end of the cylindrical barrel.

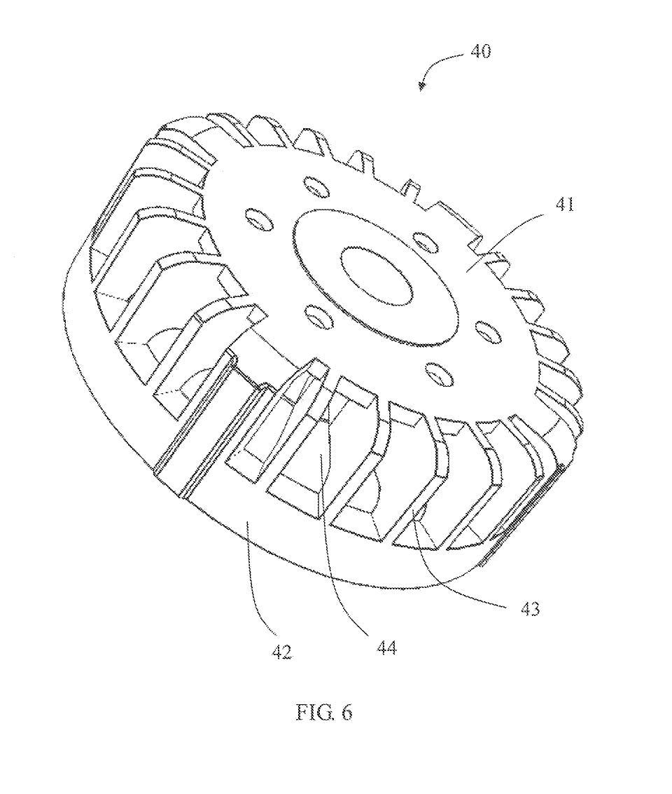

Referring to FIG. 6, the end plate 40 includes a round base plate 41 and an annular sidewall 42 extending from an outer edge of the base plate 41. A plurality of openings 44 is formed at a junction between the base plate 41 and the sidewall 42. Fan blades 43 are integrally formed at each opening. Preferably, the openings 44 are evenly distributed in a circumferential direction of the base plate 41, with the fan blades 43 surrounding the shaft 31. A first end of the sidewall 42 of the end plate 40 is fixed to the rotor core 32, by embedding the second end 35 of the connecting bars 33 into the sidewall 42. A second end of the sidewall 42 is connected with the base plate 41, and the base plate 41 is fixedly connected to the shaft 31. The base plate 41, sidewall 42 and the fan blades 43 are integrally formed at the end of the rotor core 32 and the shaft 31 from the same material by insert-molding.

The stator rotatably supports the shaft 31 through one or more bearings mounted in the sleeve 22 of the base 21, or the sleeve forms a bushing to directly support the shaft as described above. The openings 44 of the end plate 44 are aligned with the stator winding in the axial direction. During operation of the motor, the fan blades 43 rotate along with the rotor core 32 and the shaft 31, thereby producing airflow for cooling the motor. Preferably, the fan blades 43 are centrifugal fan blades, and the airflow generated by the fan blades flows into the interior of the motor via the end adjacent the circuit board 29, flows over the stator winding 28, and is exhausted through the openings 44 of the end plate 40, thus helping to dissipate the heat inside the motor. When flowing over the circuit board 29, the airflow can also cool electronic components on the circuit board 29.

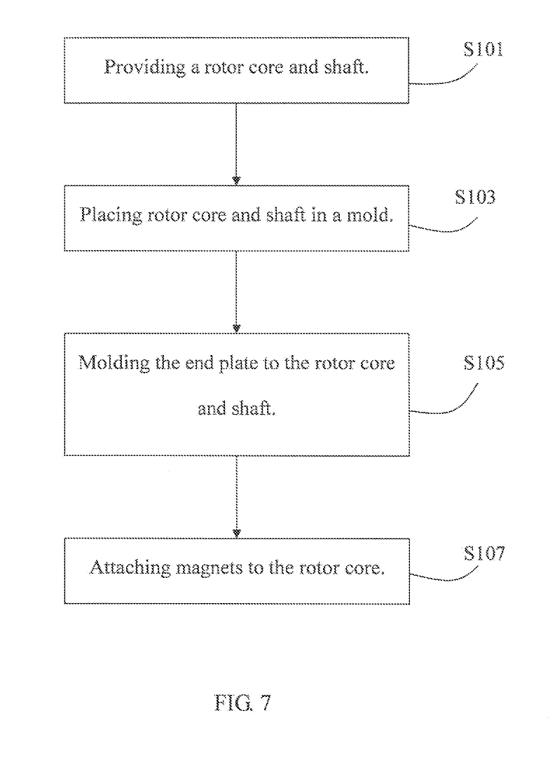

Referring to FIG. 7, a method for making the outer rotor includes the following steps.

At step S101, a rotor core having connecting bars is provided. Specifically, one end of the connecting bar is fixedly connected to the rotor core, and the other end extends out of the rotor core in an axial direction of the rotor core. In one embodiment of the present invention, the rotor core is formed by stacking a plurality of core laminations with through holes. A plurality of connecting bars with bar heads is inserted into the through holes, respectively, along the axial direction of the connecting bars, and the other ends of the connecting bars protrude out of the core laminations. In another embodiment of the present invention, the rotor core is of a non-stacking type. For example, the rotor core is a cylindrical barrel made of magnetically conductive material, and connecting holes are formed at one end of the cylindrical barrel. First ends of the connecting bars are mounted in the connecting holes, and second ends of the connecting bars protrude from the connecting holes in the axial direction of the rotor core. In another embodiment, the connecting bars may also be integrally formed on one end of the cylindrical barrel.

At step S103, the shaft and the rotor core with the connecting bars are placed into a mold, with the shaft located on the rotary center of the rotor core.

At step S105, the end plate is formed by injection molding such that the end plate, the protruding ends of the connecting bars and the shaft are fixed together. Preferably, the outer diameter of the end plate is less than or equal to the outer diameter of the rotor core.

At step S107, after the end plate is formed by injection molding, a plurality of permanent magnets is fixedly mounted to an inner surface of the rotor core. In this embodiment, the permanent magnets are fixedly mounted to the inner surface of the rotor core with adhesive. It should be understood that the permanent magnets can be fixed in another suitable manner.

At step S105, during injection molding of the end plate, the method further includes forming the end plate with an annular sidewall fixed to the connecting bars, a base plate fixedly connected to the shaft and a plurality of fan blades integrally connecting the sidewall and the base plate and surrounding the shaft, and a plurality of openings formed between the fan blades.

After the outer rotor is fabricated, the outer rotor is assembled to the stator as shown in FIG. 2, thus completing the fabrication of the motor.

In the description and claims of the present application, each of the verbs “comprise”, “include”, “contain” and “have”, and variations thereof, are used in an inclusive sense, to specify the presence of the stated item or feature but do not preclude the presence of additional items or features.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of example only, and various other modifications will be apparent to persons skilled in the field without departing from the scope of the invention as defined by the appended claims.

1. An outer rotor for a brushless motor, comprising:
an end plate;
a shaft fixed to a rotary center of the end plate;
an annular rotor core having one end connected to the end plate; and
a plurality of connecting bars extending in an axial direction of the rotor core, each connecting bar having a first end fixed to the rotor core and a second end fixed to the end plate.

2. The outer rotor of claim 1, wherein the second ends of the connecting bars protrude out of the rotor core, and the end plate is fixed to the second ends of the connecting bars and the shaft by insert-molding.

3. The outer rotor of claim 1, wherein the second ends of the connecting bars comprise detent structures for reinforcing the connection between the connecting bars and the end plate.

4. The outer rotor of claim 1, wherein the outer rotor further comprises a plurality of permanent magnets attached to an inner surface of the rotor core and distributed in a circumferential direction of the rotor.

5. The outer rotor of claim 1, wherein the end plate comprises a base plate, a sidewall, and a plurality of fan blades interconnecting the base plate and the sidewall and integrally formed with the base plate and the sidewall, the fan blades surround the shaft, openings are formed between adjacent fan blades for passage of airflow generated by rotation of the fan blades.

6. The outer rotor of claim 1, wherein the rotor core is formed by stacking a plurality of core laminations in an axial direction of the rotor, each core lamination has pre-formed connecting holes, the connecting bars extend through the connecting holes of the rotor core, first ends of the connecting bars comprise bar heads, and second ends of the connecting bars protrude out of the rotor core.

7. The outer rotor of claim 6, wherein the bar heads engage with a reinforcing ring disposed against an axial end of the rotor core remote from the end plate.

8. The outer rotor of claim 1, wherein an outer diameter of the end plate is less than or equal to an outer diameter of the rotor core.

9. A brushless motor comprising a stator and the outer rotor of claim 1, the stator comprising a base and a stator core fixed to the base, the base comprises a bearing for supporting the shaft, the stator core being at least partially surrounded by the rotor core.

10. A method of making an outer rotor for a brushless motor, comprising:
providing a rotor core with a plurality of connecting bars, first ends of the connecting bars being connected with the rotor core, and second ends of the connecting bars protruding out of the rotor core in an axial direction of the rotor core;
placing a shaft and the rotor core with the connecting bars into a mold, with the shaft located at a rotary center of the rotor core; and
injection molding an end plate, and fixing the end plate, the second ends of the connecting bars and the shaft together by insert-molding.

11. The method of claim 10, wherein after injection molding of the end plate is completed, a number of permanent magnets are mounted to an inner surface of the rotor core.

12. The method of claim 10, wherein during injection molding of the end plate, the method further comprises the step of: forming the end plate with a base plate, an annular sidewall and a plurality of fan blades interconnecting the base plate and the sidewall, and openings between the fan blades for the passage of airflow.
